(19) United States
(12) Patent Application Publication
(10) Pub. No.: US 2025/0131461 A1
(43) Pub. Date: Apr. 24, 2025

(54) PRODUCT DESIGN PREDICTION USING MACHINE LEARNING

(71) Applicant: Dell Products L.P., Round Rock, TX (US)

(72) Inventors: Arvind Jagannathan, Round Rock, TX (US); Bijan Kumar Mohanty, Austin, TX (US); Hung Dinh, Austin, TX (US)

(21) Appl. No.: 18/492,869

(22) Filed: Oct. 24, 2023

(51) Int. Cl. G06Q 30/0202; G06Q 30/0282

(52) U.S. Cl. CPC G06Q 30/0202; G06Q 30/0282

(57) ABSTRACT

A method comprises receiving a request to predict a plurality of scores for a plurality of satisfaction metrics for a product, wherein the request identifies a plurality of factors associated with the product. The request is input to a multiple output classification machine learning model. Using the multiple output classification machine learning model, the plurality of scores are predicted in response to the request. The multiple output classification machine learning model is trained with at least one dataset comprising historical product satisfaction data corresponding to respective ones of a plurality of products.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to management of product development in computing environments.

### BACKGROUND

Software and hardware products have numerous features, functions and applications that must be decided upon by design engineers during the development process. Such decisions on which features, functions and/or application to incorporate into a given product may be based on feedback received from users regarding their satisfaction with existing products or versions of the products. However, given the large number of variables that may factor into a satisfaction determination, current techniques lack functionality to determine which product attributes may require modification or further development.

### SUMMARY

Embodiments provide a multi-dimensional prediction platform in an information processing system.

For example, in one embodiment, a method comprises receiving a request to predict a plurality of scores for a plurality of satisfaction metrics for a product, wherein the request identifies a plurality of factors associated with the product. The request is input to a multiple output classification machine learning model. Using the multiple output classification machine learning model, the plurality of scores are predicted in response to the request. The multiple output classification machine learning model is trained with at least one dataset comprising historical product satisfaction data corresponding to respective ones of a plurality of products.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a multi-dimensional prediction platform in an illustrative embodiment.

FIG. 2 depicts an example user interface for the collection of multi-dimensional product satisfaction data in an illustrative embodiment.

FIG. 3 depicts an operational flow for a dimension prediction engine to predict scores for a plurality of product satisfaction metrics in an illustrative embodiment.

FIG. 4 depicts example training data in an illustrative embodiment.

FIG. 5 depicts example pseudocode for importation of libraries in an illustrative embodiment.

FIG. 6 depicts example pseudocode for loading historical product satisfaction data into a data frame in an illustrative embodiment.

FIG. 7 depicts example pseudocode for encoding training data in an illustrative embodiment.

FIG. 8 depicts example pseudocode for splitting a dataset into training and testing components and for creating separate datasets for independent and dependent variables in an illustrative embodiment.

FIG. 9 depicts example pseudocode for building a neural network in an illustrative embodiment.

FIG. 10 depicts example pseudocode for compiling and training the neural network in an illustrative embodiment.

FIG. 11A depicts a graphical distribution of different types of users across a plurality of regions in an illustrative embodiment.

FIG. 11B depicts a tabular distribution of different types of users across a plurality of regions in an illustrative embodiment.

FIG. 11C depicts a graphical distribution of the different types of users from FIGS. 11A and 11B in an illustrative embodiment.

FIG. 12 depicts a graphical distribution of user sentiments about a given product for a plurality of product satisfaction metrics and an overall satisfaction in an illustrative embodiment.

FIG. 13 depicts a graphical distribution of product satisfaction of a plurality of users across a plurality of regions in an illustrative embodiment.

FIG. 14 depicts a process for prediction of scores for a plurality of product satisfaction metrics according to an illustrative embodiment.

FIGS. 15 and 16 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

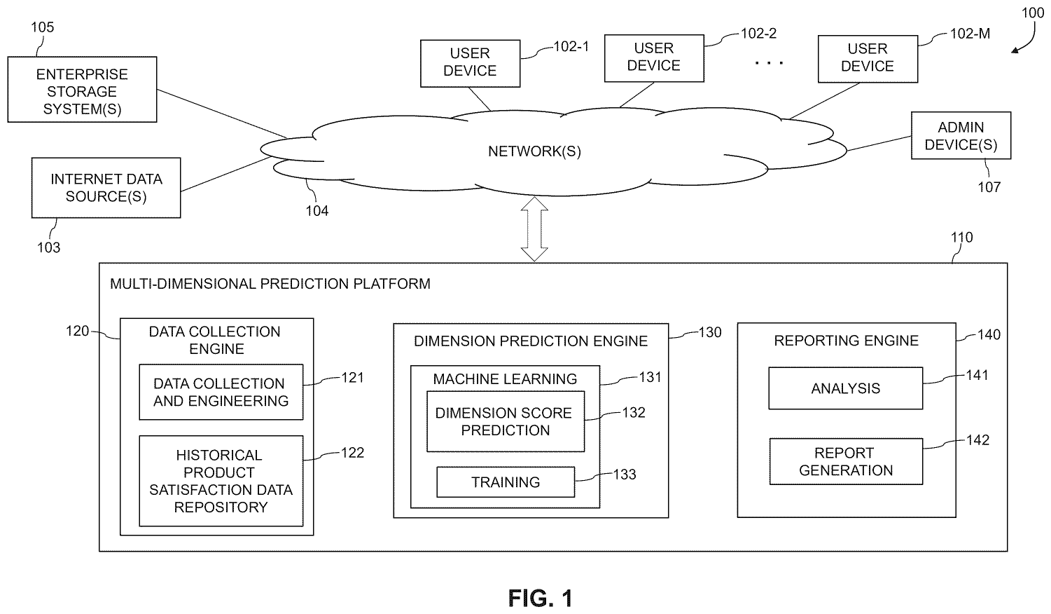

FIG. 1 shows an information processing system 100 configured in accordance with an illustrative embodiment. The information processing system 100 comprises user devices 102-1, 102-2, . . . 102-M (collectively “user devices 102”), one or more Internet data sources 103, one or more enterprise storage systems 105, and one or more administrator devices (“Admin device(s)”) 107. The user devices 102, Internet data sources 103, enterprise storage systems 105 and administrator devices 107 communicate over a network 104 with a multi-dimensional prediction platform 110. The variable M and other similar index variables herein such as K and L are assumed to be arbitrary positive integers greater than or equal to one.

The user devices 102, Internet data sources 103, enterprise storage systems 105 and administrator devices 107 can comprise, for example, Internet of Things (IoT) devices, desktop, laptop or tablet computers, mobile telephones, or other types of processing devices capable of communicating with the multi-dimensional prediction platform 110 over the network 104. Such devices are examples of what are more generally referred to herein as “processing devices.” Some of these processing devices are also generally referred to herein as “computers.” The user devices 102, Internet data sources 103, enterprise storage systems 105 and administrator devices 107 may also or alternately comprise virtualized computing resources, such as virtual machines (VMs), containers, pods, etc. The user devices 102, Internet data sources 103, enterprise storage systems 105 and administrator devices 107 in some embodiments comprise respective computers associated with a particular company, organization or other enterprise.

The Internet data sources 103, in some embodiments, comprise, but are not necessarily limited to, social media websites and/or platforms, product review websites and/or platforms, survey websites and/or platforms, online forums and/or any other sources of product satisfaction data. As used herein, “products” are to be broadly construed to refer to, for example, offerings of an enterprise, including but not necessarily limited to, programs, applications or other types of software and firmware, services (e.g., Function-as-a-Service (“FaaS”), Containers-as-a-Service (“CaaS”) and/or Platform-as-a-Service (“PaaS”) offerings), storage systems and services (e.g., cloud storage, datacenters, etc.), infrastructure management, edge services, hardware or other types of products.

As used herein, “product satisfaction data” is to be broadly construed to refer to, for example, data including direct and/or indirect feedback from the customers or other users or consumers of products. The feedback may comprise unsolicited statements made by users or consumers about product satisfaction made on, for example, social media websites and/or platforms, product review websites and/or platforms and online forums, responses to questions directly posed to users or consumers from, for example, product providers, and/or responses to questions embedded in product satisfaction surveys. The feedback can be provided via, for example, the user devices 102. As explained in more detail herein, the product satisfaction data includes satisfaction evaluation based on a plurality of satisfaction metrics, including, for example, the following seven dimensions: (i) value, indicating whether a product provides value (e.g., is valuable) to a user; (ii) functionality, indicating whether a product provides required functionality for task and/or job performance (e.g., whether a product has required functionality users to successfully do their jobs); (iii) usability, indicating whether a product is easy to use and/or consume; (iv) performance, indicating whether a product performs at a desired level of user expectation (e.g., performance may be based on speed, accuracy, efficiency, etc.); (v) learnability, indicating whether a product is easy to learn and understand; (vi) reliability, indicating whether a product produces consistent results (e.g., whether a user trusts the product with its data and connectivity); and (vii) look and feel (also referred to herein as “appearance”), indicating whether a product appears contemporary and modern to a user. Although the embodiments are described in connection with the above seven satisfaction metrics, the embodiments are not necessarily limited thereto, and more or less than the seven satisfaction metrics, including different metrics than those listed.

The enterprise storage systems 105, in some embodiments, comprise, but are not necessarily limited to, storage systems of enterprises or other organizations which maintain databases, repositories or other data stores of product satisfaction data in different formats. For example, an enterprise which designs and develops the products may maintain such databases, repositories or other data stores of product satisfaction data to use in connection with improving their existing products.

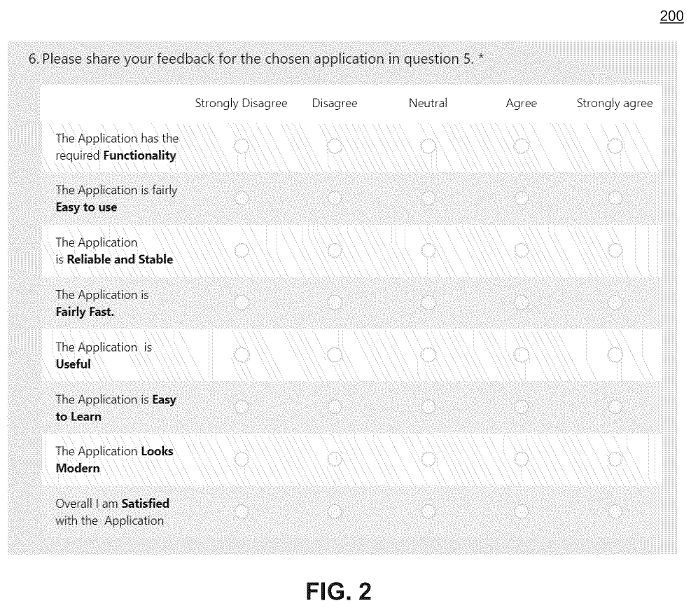

In a non-limiting operational example, referring to the user interface 200 for the collection of multi-dimensional product satisfaction data in FIG. 2, an enterprise may seek user impressions of a given product in connection with the different satisfaction metrics and overall satisfaction with the product. In the user interface 200, which may be accessed via one or more of the user devices 102, a user is asked whether they strongly disagree, disagree, are neutral, agree or strongly agree with statements regarding respective ones a plurality of satisfaction metrics (e.g., functionality, usability, reliability, performance, value, learnability, appearance and overall satisfaction) for a given application. In other instances, users may be asked to score respective ones a plurality of satisfaction metrics on different scales (e.g., 1 to 5, 1 to 7, 1 to 10, etc.) with the higher numbers indicating higher levels of agreement that the product satisfies a given satisfaction metric. Such results of enterprises seeking user impressions of their products in connection with the different satisfaction metrics may be stored in and accessed from the enterprise storage systems 105.

The term “storage system” as used herein is intended to be broadly construed, and should not be viewed as being limited to content addressable storage systems or flash-based storage systems. A given enterprise storage system 105 as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing enterprise storage systems 105 in illustrative embodiments include all-flash and hybrid flash storage arrays, software-defined storage products, cloud storage products, object-based storage products, and scale-out NAS clusters. Combinations of multiple ones of these and other storage products can also be used in implementing a given enterprise storage system 105 in an illustrative embodiment.

The terms “user,” “customer,” “consumer” or “administrator” herein are intended to be broadly construed so as to encompass numerous arrangements of human, hardware, software or firmware entities, as well as combinations of such entities. Product design prediction services may be provided for users utilizing one or more machine learning models, although it is to be appreciated that other types of infrastructure arrangements could be used. At least a portion of the available services and functionalities provided by the multi-dimensional prediction platform 110 in some embodiments may be provided under FaaS, CaaS and/or PaaS models, including cloud-based FaaS, CaaS and PaaS environments.

Although not explicitly shown in FIG. 1, one or more input-output devices such as keyboards, displays or other types of input-output devices may be used to support one or more user interfaces to the multi-dimensional prediction platform 110, as well as to support communication between the multi-dimensional prediction platform 110 and connected devices and systems (e.g., user devices 102, Internet data sources 103, enterprise storage systems 105 and administrator devices 107) and/or other related systems and devices not explicitly shown.

In some embodiments, the administrator devices 107 are assumed to be associated with repair technicians, system administrators, information technology (IT) managers, software developers, release management personnel or other authorized personnel configured to access and utilize the multi-dimensional prediction platform 110.

As noted above, challenges exist with current approaches in that the product design and development engineers are usually unaware of why consumers may be satisfied or dissatisfied with products and what product features may be the cause of the satisfaction or dissatisfaction. Users may understand and process the word “satisfaction” differently. The embodiments attempt to address these challenges by harnessing machine learning techniques to analyze and make predictions about the satisfaction of proposed product designs based on multiple dimensions (e.g., satisfaction metrics) which can influence product satisfaction.

The illustrative embodiments advantageously leverage a multiple output classification machine learning algorithm to predict a plurality of scores for a plurality of satisfaction metrics for a proposed product. The multiple outputs (also referred to herein as “targets”) comprise, for example, a score (e.g., on a scale of 1 to 10) for each of the seven dimensions noted herein above. The machine learning model is trained with, for example, historical product satisfaction data from multiple customers for multiple products. The trained model analyzes multiple incoming factors for a given product to predict the satisfaction metric scores based, at least in part, on the historical product satisfaction data.

The multi-dimensional prediction platform 110 in the present embodiment is assumed to be accessible to the user devices 102, Internet data sources 103, enterprise storage systems 105 and/or administrator devices 107 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the multi-dimensional prediction platform 110 includes a data collection engine 120, a dimension prediction engine 130 and a reporting engine 140. The data collection engine 120 includes a data collection and engineering layer 121 and a historical product satisfaction data repository 122. The dimension prediction engine 130 includes a machine learning layer 131 comprising dimension score prediction and training layers 132 and 133. The reporting engine 140 includes an analysis layer 141 and a report generation layer 142.

In order to build and update the historical product satisfaction data repository 122, the data collection and engineering layer 121 of the data collection engine 120 extracts and collects product satisfaction data from multiple sources including, but not necessarily limited to, the Internet data sources 103 and enterprise storage systems 105. In addition, the product satisfaction data can be collected from user devices 102 of users who may be providing product satisfaction data in the various forms and through the various methods described above. As noted hereinabove, the product satisfaction data may include product satisfaction feedback in the form of unsolicited statements made by users or consumers, responses to questions directly posed to users or consumers, and/or responses to questions in product satisfaction surveys. The product satisfaction data includes satisfaction evaluations based on the plurality of satisfaction metrics.

As explained in more detail herein, the historical product satisfaction data stored in the historical product satisfaction data repository 122 is input to the dimension prediction engine 130 to be used as training data by the training layer 133. The historical product satisfaction data is used to train the machine learning model(s) used by the dimension score prediction layer 132 to learn different combinations of product details for respective products leading to different combinations of satisfaction metric scores. For example, different combinations of product details such as, but not necessarily limited to, product type, domain, programming language, corresponding database, region and deployment type, result in different scores for a value metric, a functionality metric, a usability metric, a performance metric, a learnability metric, a reliability metric and an appearance metric.

In connection with building and updating the historical product satisfaction data repository 122, the data collection and engineering layer 121 of the data collection engine 120 performs data engineering and exploratory data analysis to identify important features (e.g., partitioned in columns, rows or other formats) that can influence the target variables, less important or unnecessary features, and correlations between the features. The data collection and engineering layer 121 is configured to remove the less important or unnecessary features to reduce data dimensions and model complexity, and improve the performance and accuracy of the model. Such data engineering and exploratory data analysis may include, but is not necessarily limited to, generating multivariate plots and/or correlation heatmaps or other confidence maps/plots to identify the significance of each feature in collected data and metadata, and filter less important data and metadata elements.

The dimension prediction engine 130, more particularly, the training layer 133 of the machine learning layer 131 uses one or more datasets from the historical product satisfaction data to train one or more machine learning models used by the dimension score prediction layer 132 to predict the satisfaction metric scores for a given product.

In accordance with one or more embodiments, in connection with a given product, an analysis layer 141 of the reporting engine 140 analyzes the predictions generated by the dimension score prediction layer 132 and a report generation layer 142 generates a report comprising the plurality of scores for respective ones of a plurality of satisfaction metrics based at least in part on the predictions. The report generation layer 142 causes transmission of the report to one or more devices (e.g., administrator devices 107) associated with a product development system so that product engineers can take appropriate action based on the report. For example, based on the report, product engineers may design or re-design products to address the satisfaction metrics with the lowest predicted scores in a given report. To monitor the impact of the product satisfaction metrics on the overall satisfaction, one or more releases/versions (e.g., sprint, story, etc.) of a product are tagged with metadata identifying one or more of the plurality of satisfaction metrics that may have been addressed in that release/version. From the tagging, a determination may be made regarding the dominant satisfaction metric governing the features of that particular release/version.

In some instances, upon receipt of the report, the one or more devices associated with the product development system may automatically make modifications to product designs and test the modified designs as part of a product development lifecycle (e.g., test software modifications for enhanced performance, reliability and/or functionality during a software development lifecycle). The report may be generated and transmitted in response to a request to predict a plurality of scores for a plurality of satisfaction metrics for a product. In one or more embodiments, administrators or other users may send feedback regarding the prediction to the training layer 133, which is configured to generate at least one additional training dataset based at least in part on the feedback, and to re-train the multiple output classification machine learning model with the at least one additional dataset.

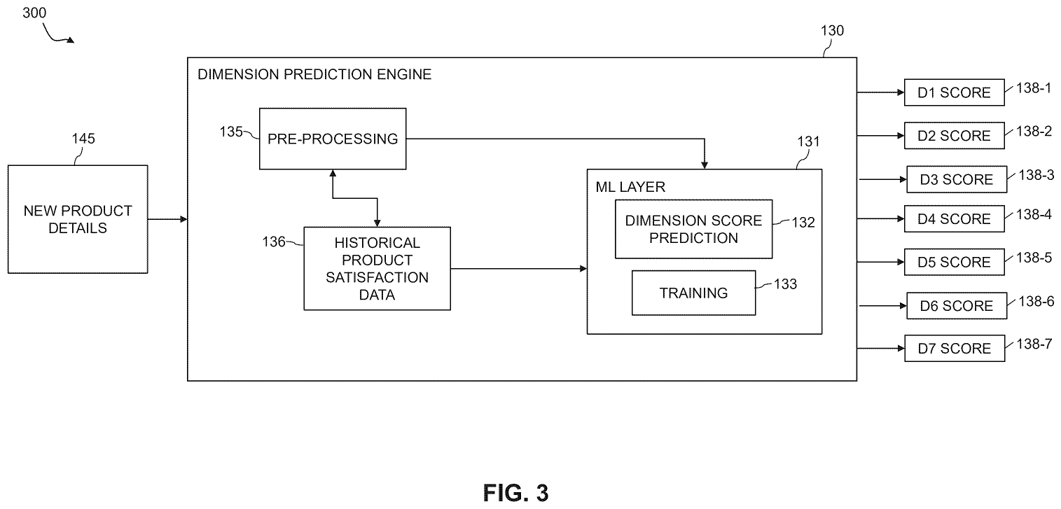

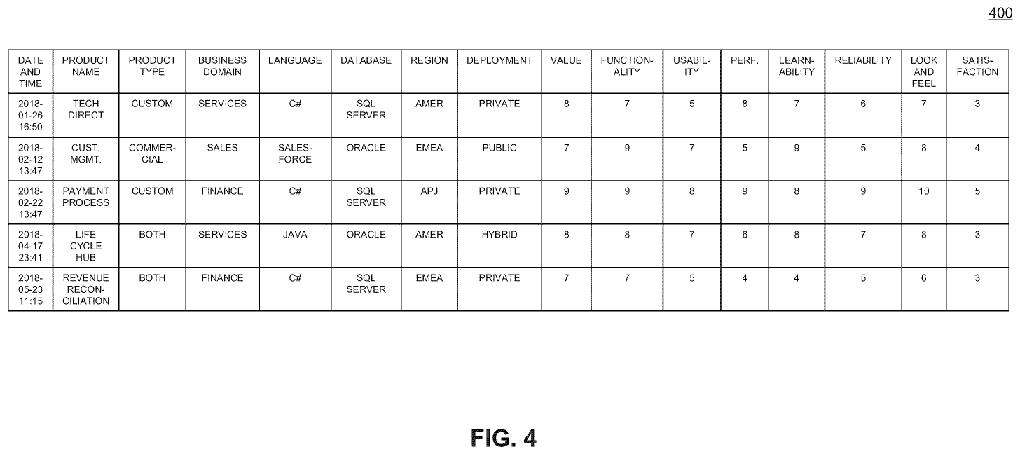

In illustrative embodiments, the dimension score prediction layer 132 uses a multiple output classification machine learning model to predict the satisfaction metric scores in response to the request. Referring to the operational flow 300 in FIG. 3, the dimension prediction engine 130 leverages historical product satisfaction data 136 from the historical product satisfaction data repository 122 to train the multiple output classification machine learning model. As explained in more detail in connection with the table 400 in FIG. 4, the historical product satisfaction data 136 comprises attributes of different products and corresponding scores for the seven satisfaction metrics described herein above. The scores in this case are based on a scale between 1 and 10. If an enterprise modifies the number of satisfaction metrics and/or adopts different satisfaction metrics, this model can be configured to change with the modifications.

In the operational flow 300, the scores for each satisfaction metric are shown as dimension 1 (D1) score 138-1, dimension 2 (D2) score 138-2, dimension 3 (D3) score 138-3, dimension 4 (D4) score 138-4, dimension 5 (D5) score 138-5, dimension 6 (D6) score 138-6 and dimension 7 (D7) score 138-7 (collectively “dimension scores 138”). The dimension prediction engine 130 predicts the dimension scores 138 from the same input dataset (new product details 145) that identifies factors including, but not necessarily limited to, date and time, product name, product type, business domain, technology used (e.g., programming language, database type, stack type), geographic region, and/or deployment type (e.g., public cloud, private cloud, hybrid cloud).

As noted herein, historical product satisfaction data 136 is used for training the multi-output (multi-target) classification model. FIG. 4 depicts example training data in an illustrative embodiment. As can be seen in the table 400, the training data identifies date and time, product name, product type (e.g., commercial and/or custom), business domain (e.g., sales, services, finance), technology used (e.g., programming language (e.g., C#, Salesforce, JAVA), database type (e.g., SQL server, Oracle), stack type), geographic region (e.g., AMER (North, Central, and South America), EMEA (Europe, the Middle East and Africa), APJ (Asia Pacific and Japan)), and/or deployment type (e.g., public cloud, private cloud, hybrid cloud). The training data in the table further identifies satisfaction metric scores (on a scale of 1 to 10) for each metric (e.g., value, functionality, usability, performance, learnability, reliability and appearance (look and feel)) for each of products, as well as scores (also on a scale of 1 to 10) for an overall satisfaction for each row.

As noted above, the data collection engine 120 performs data engineering and exploratory data analysis to identify important features (e.g., partitioned in columns, rows or other formats) that can influence the target variables, less important or unnecessary features, and correlations between the features so as to remove the less important or unnecessary features to reduce data dimensions and model complexity, and improve the performance and accuracy of the model.

Referring back to the operational flow 300, the dimension score prediction layer 132 of the machine learning layer 131 leverages a deep neural network that has seven parallel processing branches, each of which act as a classifier to predicting respective scores for respective ones of a plurality of satisfaction metrics. A request comprising new product details 145 is received from, for example, an administrator (e.g., design professional) seeking an evaluation of a proposed product design. The new product details 145 identify a plurality of factors including, but not necessarily limited to, product name, product type, domain (e.g., business domain), programming language, corresponding database, region and deployment type. The new product details 145 are input to the dimension prediction engine 130. The dimension prediction engine 130 illustrates a pre-processing component 135, which processes the incoming request and the historical product satisfaction data 136 for analysis by the machine learning (ML) layer 131. For example, the pre-processing component 135 removes any unwanted characters, punctuation, and stop words. As can be seen in FIG. 3, the dimension prediction engine 130 predicts the dimension scores 138 using the ML layer 131 comprising dimension score prediction and training layers 132 and 133.

The dimension score prediction layer 132 utilizes a multi-output neural network. In more detail, the dimension score prediction layer 132 utilizes a multiple output classification machine learning model comprising a neural network having a plurality of parallel processing branches corresponding to respective ones of the plurality of satisfaction metrics (e.g., seven parallel processing branches in this case, but not necessarily limited thereto). The plurality of parallel processing branches are connected to the same input layer. Each branch processes the same input based on the new product details 145.

The multiple output classification machine learning model comprises a plurality of output layers corresponding to respective ones of the plurality of processing branches. Each of the plurality of output layers comprises a plurality of neurons respectively corresponding to possible values for the plurality of scores. For example, if the range of possible values is 1 to 10 for each satisfaction metric score, each output layer comprises 10 neurons for values 1 to 10. In an illustrative embodiment, respective ones of the plurality of neurons use a Softmax activation function to classify respective ones of the plurality of scores.

The neural network comprises the input layer, one or more (in this case 2) hidden layers and the output layer. The input layer includes a number of neurons that matches the number of input/independent variables (e.g., the plurality of factors or a subset of the plurality of factors identified in the new product details 145). The number of neurons in each hidden layer depends on the number of neurons in the input layer. As noted above, the output layer for each branch includes a number of neurons corresponding to possible values for the plurality of scores. A Rectified Linear Unit (ReLU) activation function controls the firing of the neurons in the hidden layers, while, as noted above, the output layers use the Softmax activation function.

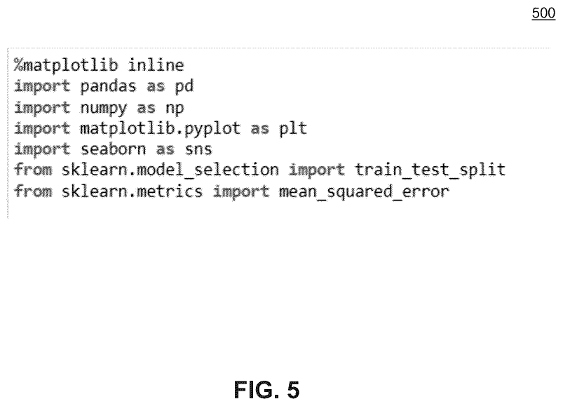

In connection with the operation of the dimension prediction engine 130, FIG. 5 depicts example pseudocode 500 for importation of libraries used to implement the dimension prediction engine 130. For example, Python, ScikitLearn, Pandas and Numpy libraries can be used. Some embodiments may implement multi-output classification using a neural network with Tensorflow® and/or Keras libraries. In connection with the data engineering and exploratory data analysis performed by the data collection engine 120 to identify important features, a training dataset is read and a data frame (e.g., Pandas data frame) corresponding to the training dataset is generated. The data frame comprises a plurality of partitioned independent variables (e.g., partitioned in columns) representing the input factors (e.g., from the new product details 145) and a plurality of partitioned dependent variables (e.g., partitioned in columns) representing the plurality of satisfaction metrics. An initial step is to pre-process the data to address any null or missing values in the partitions (e.g., columns). Null and/or missing values in partitions with numerical data can be replaced by the median value of that partition or other average value (e.g., mean). After generating univariate and/or bivariate plots of the partitions, the importance and influence of each partition is determined. Partitions that have little or no role or influence on the actual prediction (target variables) can be dropped. In other words, one or more of a plurality of partitioned independent variables are identified to remove from the training dataset based at least in part on whether the one or more of the plurality of partitioned independent variables factor into the prediction of the plurality of scores. The identified one or more of the plurality of partitioned independent variables are removed from the training dataset, and the multiple output classification machine learning model is trained with the modified training dataset.

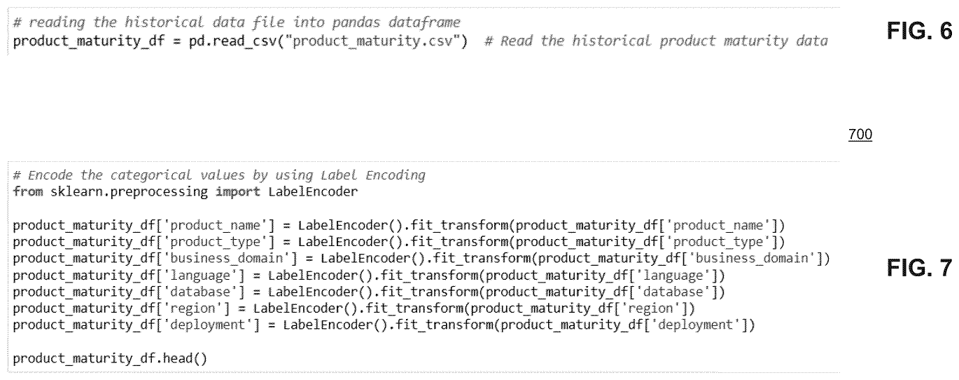

FIG. 6 depicts example pseudocode 600 for loading the historical product satisfaction data into a Pandas data frame for building the training data. Referring back to the pre-processing component 135 in FIG. 3, since machine learning works with numbers, categorical and textual attributes like product name, product type, business domain, programming language, database type, region, deployment type, etc. must be encoded before being used as training data. In one or more embodiments, this can be achieved by leveraging a LabelEncoder function of ScikitLearn library as shown in the pseudocode 700 in FIG. 7.

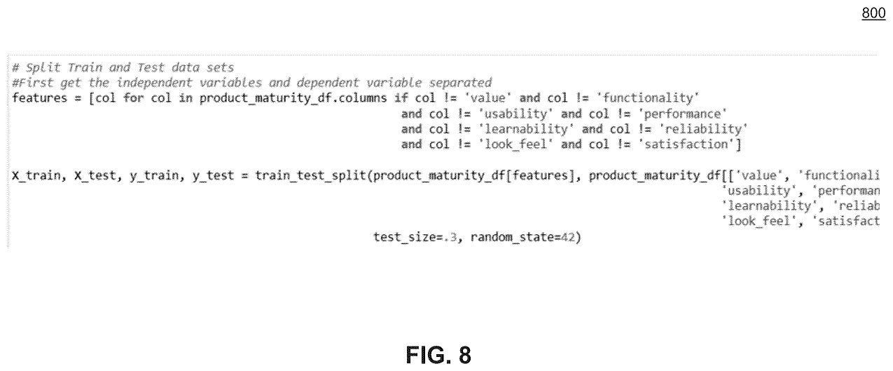

According to illustrative embodiments, the encoded training dataset is split into training and testing datasets, and separate datasets are created for independent variables and dependent variables. For example, some embodiments use seven dependent variables (e.g., value, functionality, usability, performance, learnability, reliability and appearance (look and feel)) or eight dependent variables (adding “satisfaction” to the noted seven dependent variables). FIG. 8 depicts example pseudocode 800 for splitting a dataset into training and testing components and for creating separate datasets for independent (X) and dependent (y) variables. The dataset is split into training and testing datasets using train_test_split function of ScikitLearn library with, for example, a 70%-30% split.

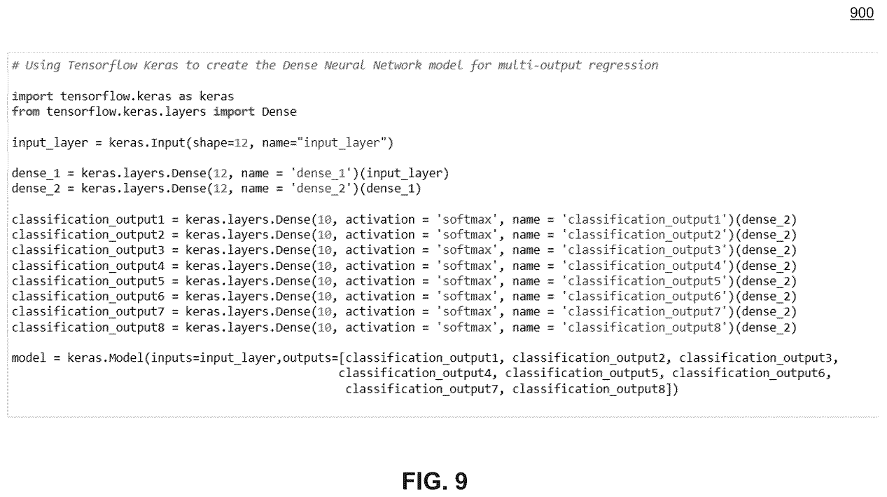

Once the datasets are ready for training and testing, a composite, multi-output (multi-target) neural network model capable of predicting multiple target variables is built. The multiple target variables include, for example, the plurality of satisfaction metrics or the plurality of satisfaction metrics plus the overall satisfaction. For example, referring to FIG. 9, which depicts example pseudocode 900 for building a neural network, a dense neural network is built using a Keras functional model. Seven separate dense layers are added to the input layer with each network being capable of predicting a target (e.g., value, functionality, usability, performance, learnability, reliability and appearance (look and feel)). Alternatively, as shown in FIG. 9, eight separate dense layers (the previously listed seven layers plus overall satisfaction) are added to the input layer with each network being capable of predicting a target.

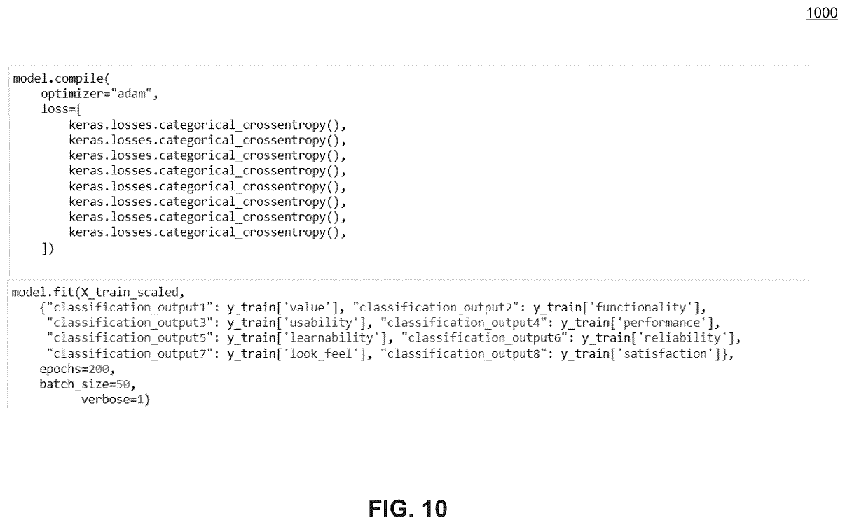

Referring to FIG. 10, which depicts example pseudocode 1000 for compiling and training the generated neural network, an Adam optimization algorithm is used as an optimizer, a categorical cross-entropy function is used as a loss function for the classifiers and mean squared error is used as a loss function for regression paths to each target. The model is trained with independent variable data (X_train) and the target variables are passed for each classification and regression path.

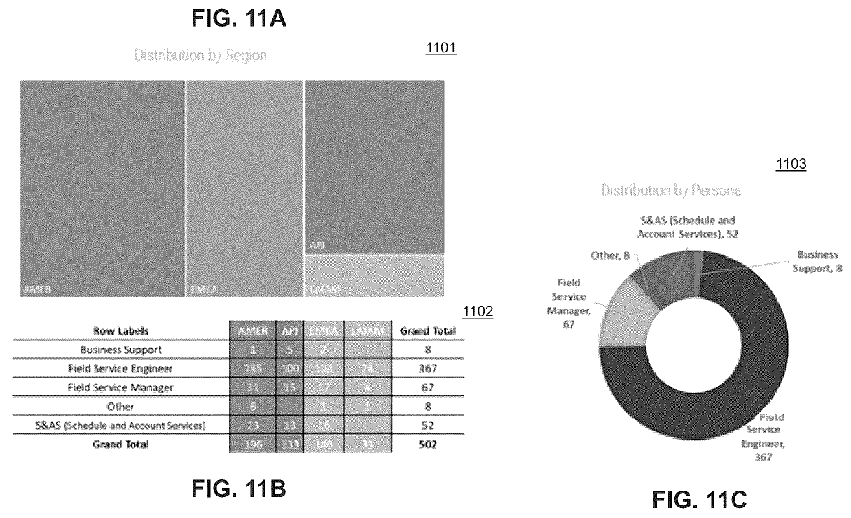

Referring to the graphical distribution 1101 in FIG. 11A, the tabular distribution 1102 in FIG. 11B and the graphical distribution 1103 in FIG. 11C, of 502 users who responded to a survey, 196 are from the AMER region, 133 are from the APJ region, 140 are from the EMEA region and 33 are from the LATAM (Latin America) region. In addition, 8 of the respondents work in business support, 367 of the respondents work as field service engineers, 67 of the respondents work as field service managers, 52 of the respondents work in schedule and account services, and 8 of the respondents work in other capacities. As can be understood from FIGS. 11A-11C, product satisfaction data may be derived from a variety of personas from different regions.

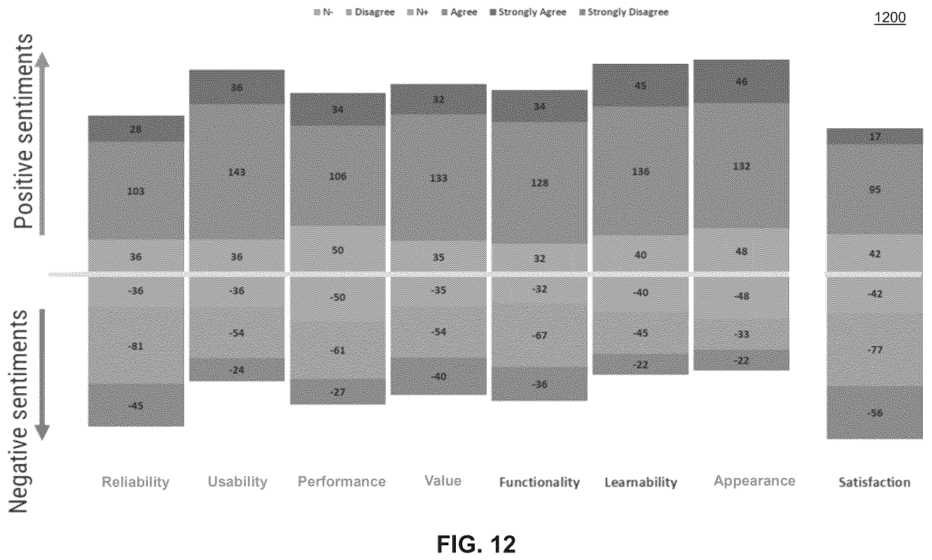

FIG. 12 depicts a graphical distribution 1200 of user sentiments about a given product for a plurality of product satisfaction metrics and an overall satisfaction. The satisfaction metrics in FIG. 12 include reliability, usability, performance, value, functionality, learnability and appearance. In this example, the responses of 328 users were analyzed. In this case all of the users represent the same persona (e.g., the same job/title) and the responses are based on the same product. The graphical distribution shows how users rated each of the product satisfaction metrics and how the ratings impact the overall satisfaction of the product. As can be seen in FIG. 12, compared to other dimensions, reliability of the product was rated lower compared to the other dimensions and may be contributing more to the overall dissatisfaction of the product.

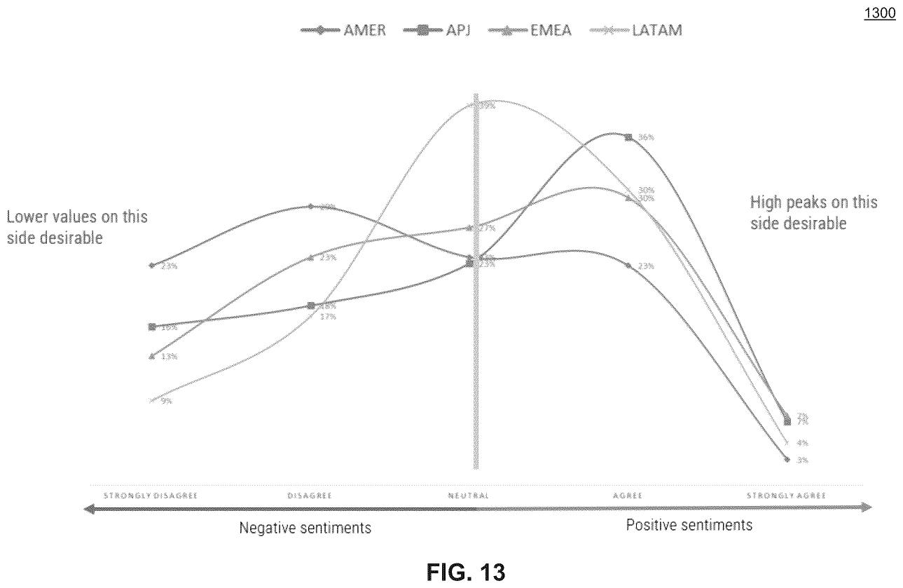

FIG. 13 depicts a graphical distribution 1300 of product satisfaction of a plurality of users across a plurality of regions for a given product. As can be understood from FIG. 13, satisfaction of a product is not universally the same across regions. Different regions interpret satisfaction differently, which is why using the product satisfaction metrics can lead to more accurate assessments of what may be worth improving about a given product. In the graphical distribution 1300 in FIG. 13, the APJ region finds the product more satisfactory compared to the AMER region, while the LATAM region produces a neutral result.

According to one or more embodiments, the historical product satisfaction data repository 122 and other data repositories or databases referred to herein can be configured according to a relational database management system (RDBMS) (e.g., PostgreSQL). In some embodiments, the historical product satisfaction data repository 122 and other data repositories or databases referred to herein are implemented using one or more storage systems or devices associated with the multi-dimensional prediction platform 110. In some embodiments, one or more of the storage systems utilized to implement the historical product satisfaction data repository 122 and other data repositories or databases referred to herein comprise a scale-out all-flash content addressable storage array or other type of storage array.

Although shown as elements of the multi-dimensional prediction platform 110, the data collection engine 120, dimension prediction engine 130 and/or reporting engine 140 in other embodiments can be implemented at least in part externally to the multi-dimensional prediction platform 110, for example, as stand-alone servers, sets of servers or other types of systems coupled to the network 104. For example, the data collection engine 120, dimension prediction engine 130 and/or reporting engine 140 may be provided as cloud services accessible by the multi-dimensional prediction platform 110.

The data collection engine 120, dimension prediction engine 130 and/or reporting engine 140 in the FIG. 1 embodiment are each assumed to be implemented using at least one processing device. Each such processing device generally comprises at least one processor and an associated memory, and implements one or more functional modules for controlling certain features of the data collection engine 120, dimension prediction engine 130 and/or reporting engine 140.

At least portions of the multi-dimensional prediction platform 110 and the elements thereof may be implemented at least in part in the form of software that is stored in memory and executed by a processor. The multi-dimensional prediction platform 110 and the elements thereof comprise further hardware and software required for running the multi-dimensional prediction platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the data collection engine 120, dimension prediction engine 130, reporting engine 140 and other elements of the multi-dimensional prediction platform 110 in the present embodiment are shown as part of the multi-dimensional prediction platform 110, at least a portion of the data collection engine 120, dimension prediction engine 130, reporting engine 140 and other elements of the multi-dimensional prediction platform 110 in other embodiments may be implemented on one or more other processing platforms that are accessible to the multi-dimensional prediction platform 110 over one or more networks. Such elements can each be implemented at least in part within another system element or at least in part utilizing one or more stand-alone elements coupled to the network 104.

It is assumed that the multi-dimensional prediction platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the data collection engine 120, dimension prediction engine 130, reporting engine 140 and other elements of the multi-dimensional prediction platform 110, and the elements thereof can each be implemented in the form of one or more LXCs running on one or more VMs. Other arrangements of one or more processing devices of a processing platform can be used to implement the data collection engine 120, dimension prediction engine 130 and reporting engine 140, as well as other elements of the multi-dimensional prediction platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the multi-dimensional prediction platform 110 to reside in different data centers. Numerous other distributed implementations of the multi-dimensional prediction platform 110 are possible.

Accordingly, one or each of the data collection engine 120, dimension prediction engine 130, reporting engine 140 and other elements of the multi-dimensional prediction platform 110 can each be implemented in a distributed manner so as to comprise a plurality of distributed elements implemented on respective ones of a plurality of compute nodes of the multi-dimensional prediction platform 110.

It is to be appreciated that these and other features of illustrative embodiments are presented by way of example only, and should not be construed as limiting in any way. Accordingly, different numbers, types and arrangements of system elements such as the data collection engine 120, dimension prediction engine 130, reporting engine 140 and other elements of the multi-dimensional prediction platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the multi-dimensional prediction platform can be offered to cloud infrastructure customers or other users as part of FaaS, CaaS and/or PaaS offerings.

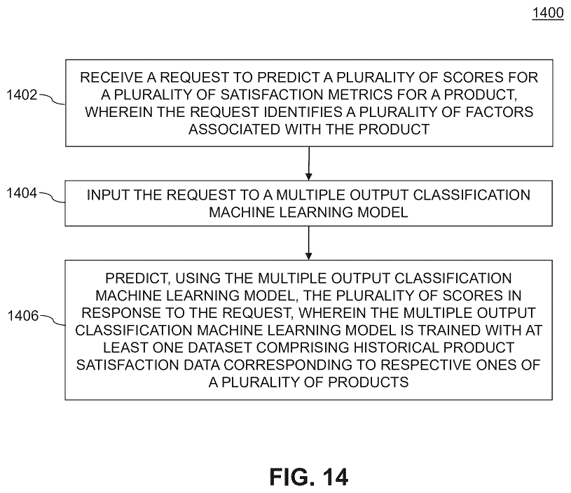

The operation of the information processing system 100 will now be described in further detail with reference to the flow diagram of FIG. 14. With reference to FIG. 14, a process 1400 for prediction of scores for a plurality of product satisfaction metrics as shown includes steps 1402-1406, and is suitable for use in the system 100 but is more generally applicable to other types of information processing systems comprising a multi-dimensional prediction platform configured for satisfaction metric score prediction.

In step 1402, a request to predict a plurality of scores for a plurality of satisfaction metrics for a product is received. The request identifies a plurality of factors associated with the product. The plurality of satisfaction metrics comprise, for example, two or more of a value metric, a functionality metric, a usability metric, a performance metric, a learnability metric, a reliability metric and an appearance metric. The plurality of factors comprise, for example, two or more of product type, domain, programming language, corresponding database, region and deployment type.

In step 1404, the request is input to a multiple output classification machine learning model. In step 1406, using the multiple output classification machine learning model, the plurality of scores are predicted in response to the request. The multiple output classification machine learning model is trained with at least one dataset comprising historical product satisfaction data corresponding to respective ones of a plurality of products. The historical product satisfaction data can be extracted from at least one of a storage system of an enterprise and one or more Internet sources.

One or more independent variable datasets and one or more dependent variable datasets are created from the at least one dataset. The one or more dependent variable datasets correspond to at least one of the value metric, the functionality metric, the usability metric, the performance metric, the learnability metric, the reliability metric and the appearance metric.

In illustrative embodiments, the multiple output classification machine learning model comprises a neural network having a plurality of parallel processing branches corresponding to respective ones of the plurality of satisfaction metrics, and wherein the plurality of parallel processing branches are connected to a same input layer. The multiple output classification machine learning model comprises a plurality of output layers, wherein respective ones of the plurality of output layers correspond to respective ones of the plurality of processing branches, and wherein the respective ones of the plurality of output layers comprise a plurality of neurons respectively corresponding to possible values for the plurality of scores. Respective ones of the plurality of neurons use a Softmax activation function to classify respective ones of the plurality of scores.

The at least one dataset is read and a data frame corresponding to the at least one dataset is generated, wherein the data frame comprises a plurality of partitioned independent variables and a plurality of partitioned dependent variables. One or more of the plurality of partitioned independent variables to remove from the at least one dataset are identified based at least in part on whether the one or more of the plurality of partitioned independent variables factor into the prediction of the plurality of scores, and the identified one or more of the plurality of partitioned independent variables are removed from the at least one dataset. The multiple output classification machine learning model is trained with the at least one dataset following the removal of the identified one or more of the plurality of partitioned independent variables.

In illustrative embodiments, a report comprising the plurality of scores for the plurality of satisfaction metrics is generated based at least in part on the prediction, and the report is transmitted to one or more devices associated with a product development system. In one or more embodiments, feedback regarding the prediction is received, at least one additional dataset is generated based at least in part on the feedback, and the multiple output classification machine learning model is re-trained with the at least one additional dataset. One or more releases of the product may be tagged with metadata corresponding to one or more of the plurality of satisfaction metrics.

It is to be appreciated that the FIG. 14 process and other features and functionality described above can be adapted for use with other types of information systems configured to execute satisfaction metric score prediction services in a multi-dimensional prediction platform or other type of platform.

The particular processing operations and other system functionality described in conjunction with the flow diagram of FIG. 14 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 14 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a multi-dimensional prediction platform as disclosed herein can provide a number of significant advantages relative to conventional arrangements. For example, the multi-dimensional prediction platform uses machine learning to predict scores for a plurality of product satisfaction metrics in connection with a given product. Technical problems exist with conventional approaches that fail to analyze and predict scores for multiple dimensions associated with product satisfaction.

Unlike conventional approaches, illustrative embodiments provide technical solutions which formulate programmatically and with a high degree of accuracy, the prediction of product satisfaction metric scores. The embodiments advantageously leverage one or more sophisticated machine learning models and train the machine learning model(s) using historical product satisfaction data corresponding to the same or similar factors as those pertaining to new products.

As an additional advantage, illustrative embodiments implement a multi-target classification model that is trained using multi-dimensional features of historical product satisfaction data. The model uses a dense neural network to predict scores for respective ones of a plurality of satisfaction metrics, wherein the prediction factors in, for example, date and time, product name, product type, business domain, technology used (e.g., programming language, database type, stack type), geographic region, and/or deployment type (e.g., public cloud, private cloud, hybrid cloud), as identified in a request for evaluation of a product. The embodiments advantageously determine the impact of the various metrics on product satisfaction and improve the machine learning model's performance based on feedback about the impact of the various metrics.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the multi-dimensional prediction platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a multi-dimensional prediction platform in illustrative embodiments. These and other cloud-based systems in illustrative embodiments can include object stores.

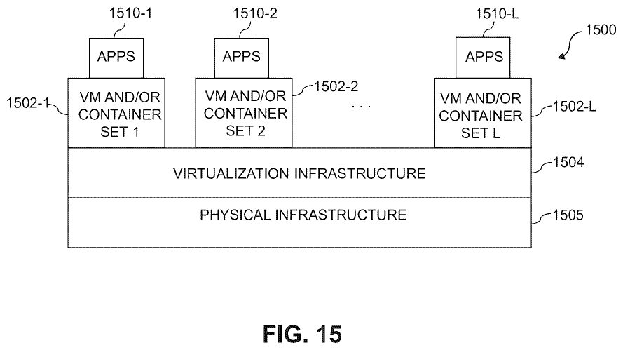

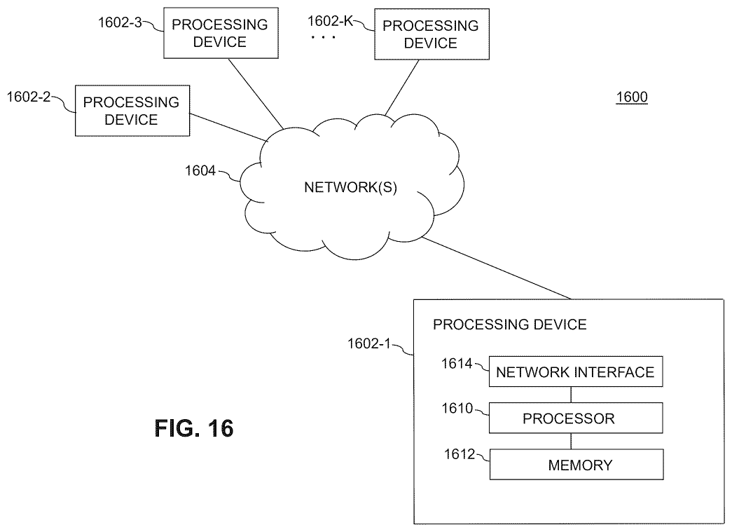

Illustrative embodiments of processing platforms will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that may be utilized to implement at least a portion of the information processing system 100. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 may comprise respective VMs, respective sets of one or more containers, or respective sets of one or more containers running in VMs.

In some implementations of the FIG. 15 embodiment, the VMs/container sets 1502 comprise respective VMs implemented using virtualization infrastructure 1504 that comprises at least one hypervisor. A hypervisor platform may be used to implement a hypervisor within the virtualization infrastructure 1504, where the hypervisor platform has an associated virtual infrastructure management system. The underlying physical machines may comprise one or more distributed processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1602-1 in the processing platform 1600 comprises a processor 1610 coupled to a memory 1612. The processor 1610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1612 may comprise random access memory (RAM), read-only memory (ROM), flash memory or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the multi-dimensional prediction platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and multi-dimensional prediction platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request to predict a plurality of scores for a plurality of satisfaction metrics for a product, wherein the request identifies a plurality of factors associated with the product;
inputting the request to a multiple output classification machine learning model; and
predicting, using the multiple output classification machine learning model, the plurality of scores in response to the request;
wherein the multiple output classification machine learning model is trained with at least one dataset comprising historical product satisfaction data corresponding to respective ones of a plurality of products; and
wherein the steps of the method are executed by at least one processing device operatively coupled to at least one memory.

2. The method of claim 1 wherein the plurality of satisfaction metrics comprise two or more of a value metric, a functionality metric, a usability metric, a performance metric, a learnability metric, a reliability metric and an appearance metric.

3. The method of claim 2 further comprising creating from the at least one dataset one or more independent variable datasets and one or more dependent variable datasets.

4. The method of claim 3 wherein the one or more dependent variable datasets correspond to at least one of the value metric, the functionality metric, the usability metric, the performance metric, the learnability metric, the reliability metric and the appearance metric.

5. The method of claim 1 wherein the plurality of factors comprise two or more of product type, domain, programming language, corresponding database, region and deployment type.

6. The method of claim 1 wherein the multiple output classification machine learning model comprises a neural network having a plurality of parallel processing branches corresponding to respective ones of the plurality of satisfaction metrics, and wherein the plurality of parallel processing branches are connected to a same input layer.

7. The method of claim 6 wherein the multiple output classification machine learning model comprises a plurality of output layers, wherein respective ones of the plurality of output layers correspond to respective ones of the plurality of processing branches, and wherein the respective ones of the plurality of output layers comprise a plurality of neurons respectively corresponding to possible values for the plurality of scores.

8. The method of claim 7 wherein respective ones of the plurality of neurons use a Softmax activation function to classify respective ones of the plurality of scores.

9. The method of claim 1 further comprising:
reading the at least one dataset and generating a data frame corresponding to the at least one dataset, wherein the data frame comprises a plurality of partitioned independent variables and a plurality of partitioned dependent variables;
identifying one or more of the plurality of partitioned independent variables to remove from the at least one dataset based at least in part on whether the one or more of the plurality of partitioned independent variables factor into the prediction of the plurality of scores; and
removing the identified one or more of the plurality of partitioned independent variables from the at least one dataset;
wherein the multiple output classification machine learning model is trained with the at least one dataset following the removal of the identified one or more of the plurality of partitioned independent variables.

10. The method of claim 1 further comprising extracting the historical product satisfaction data from at least one of a storage system of an enterprise and one or more Internet sources.

11. The method of claim 1 further comprising:
generating a report comprising the plurality of scores for the plurality of satisfaction metrics based at least in part on the prediction; and
cause transmission of the report to one or more devices associated with a product development system.

12. The method of claim 1 further comprising:
receiving feedback regarding the prediction; and
generating at least one additional dataset based at least in part on the feedback;
wherein the multiple output classification machine learning model is re-trained with the at least one additional dataset.

13. The method of claim 1 further comprising tagging one or more releases of the product with metadata corresponding to one or more of the plurality of satisfaction metrics.

14. An apparatus comprising:
a processing device operatively coupled to a memory and configured:
to receive a request to predict a plurality of scores for a plurality of satisfaction metrics for a product, wherein the request identifies a plurality of factors associated with the product;
to input the request to a multiple output classification machine learning model; and
to predict, using the multiple output classification machine learning model, the plurality of scores in response to the request;
wherein the multiple output classification machine learning model is trained with at least one dataset comprising historical product satisfaction data corresponding to respective ones of a plurality of products.

15. The apparatus of claim 14 wherein the multiple output classification machine learning model comprises a neural network having a plurality of parallel processing branches corresponding to respective ones of the plurality of satisfaction metrics, and wherein the plurality of parallel processing branches are connected to a same input layer.

16. The apparatus of claim 15 wherein the multiple output classification machine learning model comprises a plurality of output layers, wherein respective ones of the plurality of output layers correspond to respective ones of the plurality of processing branches, and wherein the respective ones of the plurality of output layers comprise a plurality of neurons respectively corresponding to possible values for the plurality of scores.

17. The apparatus of claim 15 wherein the processing device is further configured:
to read the at least one dataset and generate a data frame corresponding to the at least one dataset, wherein the data frame comprises a plurality of partitioned independent variables and a plurality of partitioned dependent variables;
to identify one or more of the plurality of partitioned independent variables to remove from the at least one dataset based at least in part on whether the one or more of the plurality of partitioned independent variables factor into the prediction of the plurality of scores; and
to remove the identified one or more of the plurality of partitioned independent variables from the at least one dataset;
wherein the multiple output classification machine learning model is trained with the at least one dataset following the removal of the identified one or more of the plurality of partitioned independent variables.

18. An article of manufacture comprising a non-transitory processor-readable storage medium having stored therein program code of one or more software programs, wherein the program code when executed by at least one processing device causes the at least one processing device to perform the steps of:
receiving a request to predict a plurality of scores for a plurality of satisfaction metrics for a product, wherein the request identifies a plurality of factors associated with the product;
inputting the request to a multiple output classification machine learning model; and
predicting, using the multiple output classification machine learning model, the plurality of scores in response to the request;
wherein the multiple output classification machine learning model is trained with at least one dataset comprising historical product satisfaction data corresponding to respective ones of a plurality of products.

19. The article of manufacture of claim 18 wherein the multiple output classification machine learning model comprises a neural network having a plurality of parallel processing branches corresponding to respective ones of the plurality of satisfaction metrics, and wherein the plurality of parallel processing branches are connected to a same input layer.

20. The article of manufacture of claim 19 wherein the multiple output classification machine learning model comprises a plurality of output layers, wherein respective ones of the plurality of output layers correspond to respective ones of the plurality of processing branches, and wherein the respective ones of the plurality of output layers comprise a plurality of neurons respectively corresponding to possible values for the plurality of scores.
